(19) United States
(12) Patent Application Publication
(10) Pub. No.: US 2009/0295712 A1
(43) Pub. Date: Dec. 3, 2009

(54) PORTABLE PROJECTOR AND METHOD OF OPERATING A PORTABLE PROJECTOR

(75) Inventor: Jan Robert Tobias RITZAU, Veberod (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/128,649

(22) Filed: May 29, 2008

(51) Int. Cl. G09G 5/00

(52) U.S. Cl. 345/156

(57) ABSTRACT

A portable projector comprising a projection unit for projecting an image onto a projection surface. The portable projector comprises a stabilization unit for stabilizing the projecting of the image. The portable projector further comprises a light sensing unit for scanning a region surrounding the portable projector.

### FIELD OF THE INVENTION

The present invention relates to a portable projector and a method of operating a portable projector, and more particularly to a portable projector comprising a projection unit for projecting an image onto a projection surface.

### BACKGROUND OF THE INVENTION

In recent years, projection systems have become wide-spread and are used for a range of different applications. Such applications include the projection of a video signal for entertainment purposes, e.g. the signal received from a DVD player or a television receiver, or the presentation of information, when for example connected to a laptop computer from which a video signal is received. Several improvements were made to these video projection systems over the last years. By the use of light emitting diodes as a light source, the heat produced by the light source was substantially reduced, as a result of which smaller size projectors can be constructed. Yet these projectors are still relatively large, i.e. 150 mm times 100 mm times 50 mm, and are generally constructed to be connected to only portable or desktop computers or stationary video signal generating systems, such as a DVD player or a TV tuner. These projectors are further constructed for only a stationary use, e.g. for being mounted to a ceiling or for being placed on a tabletop.

On the other hand, mobile electronic devices, such as mobile phones, personal digital assistants (PDA), or mobile media players are equipped with an ever increasing functionality. Accordingly, they require large screen sizes in order to display a range of information, including menu structures as well as pictures or video. Further, they require a plurality of control elements, such as keys and push buttons, or more sophisticated input devices, such as a touch screen or speech control, for being able to make use of the provided functionality. Yet there is only limited space available on a mobile electronic device. Accordingly, there is a limit to the screen size and the number of control elements that a mobile electronic device can carry. There is the need to improve both the display system of such an electronic device and the way of operating such a device. There is further the need to provide a display unit that is more versatile and easier to use. It is also necessary to improve the ergonomics of such a device, in particular regarding the input of control or other information.

### SUMMARY OF THE INVENTION

The present invention provides a portable projector and a method of operating a portable projector.

According to a first aspect of the invention, a portable projector comprises a projection unit for projecting an image onto a projection surface and a stabilization unit stabilizing the projecting of the image. Further, the portable projector is provided with a light sensing unit for scanning a region surrounding said portable projector, the portable projector being configured to operate a user interface by detecting a user input by means of said light sensing unit. Such a projector combines display and input capabilities. It may be designed to be compact and suitable for mobile applications.

According to an embodiment of the invention, the light sensing unit is configured to capture picture data, the stabilization unit stabilizing the projecting of the image on the basis of said captured picture data. Data delivered by the light sensing unit may thus be used both for stabilizing the projecting and for detecting a user input. The stabilization unit may for example be configured to correct for movements of the projection surface. In an embodiment, the projection surface comprises at least a part of a hand of the user. In such a configuration, the projection surface is generally always available and no additional equipment is required.

In another embodiment, the stabilization unit is configured to correct for movements of the portable projector. The stabilization unit may for example be configured to correct for relative movements between portable projector and projection surface, or may be configured to correct separately for projector movement and projection surface movement.

According to another embodiment of the invention, the portable projector further comprises a processing unit analyzing picture data captured by said light sensing unit for a user controlled object. The processing unit is configured to detect a user input by detecting a variation of said user controlled object. Just as an example, a variation may be a movement, a rotation, a deformation, a bending, and the like of a user controlled object, or may be a gesture by the user controlled object or a change of its texture, or combination thereof. The user controlled object may for example be a hand, a palm, a finger, a pen, a ring, or a reflector, or a combination thereof. Just as an example, the waving of a hand, or the flipping of a finger may be detected as a user input. As another example, the deformation of the texture of a palm may be detected as a user input.

According to another embodiment, the portable projector further comprises a connection unit for establishing a connection to an electronic device. The portable projector may then be configured to operate as a display unit and as a user interface for the electronic device. The connection may be a wired connection, yet in another embodiment, it is a wireless connection. A user may thus for example not have to access the electronic device in order to display information or to provide an input to the electronic device.

According to a further embodiment of the invention, the portable projector comprises a processing unit processing picture data captured by said light sensing unit for detecting a position and a shape of the projection surface. The processing unit is configured for adjusting the projecting of the image in accordance with the detected position and shape. Accordingly, an optimization of the shape of the projected image may be enabled.

According to yet another embodiment, the portable projector further comprises a processing unit processing picture data captured by said light sensing unit for detecting at least one marker present in the region observed by said light sensing unit. The stabilization unit is then configured to adjust the projecting of the image in accordance with a position of the at least one marker. A marker may for example be easier to detect in the captured picture data, so that the stabilization of the projecting of the image can be improved.

The portable projector of yet another embodiment comprises an image correction unit configured to correct the projected image on the basis of picture data captured by the light sensing unit. The projected image is corrected for at least one projection surface property, such as a color, a texture, a curvature, or a shape of the projection surface, or similar projection surface properties. Such a correction may provide an improved image quality.

According to a further embodiment, the portable projector comprises a processing unit for analyzing picture data captured by the light sensing unit for a deformation of the projection surface and for interpreting a predetermined detected deformation as a user input. According to a further embodiment, the portable projector is provided with a processing unit for analyzing picture data captured by said light sensing unit for a shadow of a user controlled object. The processing unit is further configured to interpret a shadow with a predetermined shape in relation to said user controlled object, or an appearance or disappearance of a shadow, as a user input.

According to a further embodiment, the portable projector is implemented as an object selected from a group comprising an earpiece, a headset, a pin, a piece of jewelry, a button, and the like.

According to a further aspect of the invention, a portable projector comprises a projection unit for projecting an image onto a projection surface, a light sensing unit for scanning a region surrounding the portable projector and a connection unit for establishing a connection to an electronic device. The portable projector is then configured to operate as a display unit for the electronic device and to operate as a user interface for the electronic device by detecting a user input by means of the light sensing unit. In an embodiment, the portable projector further comprises a stabilization unit stabilizing the projected image based on picture data captured by the light sensing unit. Just as an example, the light sensing unit may be implemented as a sensor selected from a group comprising a charge coupled device (CCD) sensor, a complementary metal-oxide-semiconductor (CMOS) sensor and a photonic mixer device (PMD) sensor. In an embodiment, the electronic device to which the connection is established is a mobile electronic device selected from the group comprising a cellular phone, a personal digital assistant (PDA), a personal navigation device (PND), a portable computer, an audio player, and a mobile multimedia device.

According to a further aspect of the invention, a portable projector comprising a projection unit for projecting an image onto a projection surface, a light sensing unit for scanning a region surrounding the portable projector, said light sensing unit capturing picture data, and a stabilization unit for stabilizing the captured image on the basis of the captured picture data is provided. The stabilization unit is configured so as to compensate a relative movement between the projection surface comprising at least part of a hand, and said portable projector. Just as an example, the stabilization unit may detect the position of a part of a hand in the captured picture data and stabilize the projecting of the image accordingly.

According to a further aspect of the invention, an electronic device comprising a separate display and user interface unit in the form of one of the above-mentioned portable projectors is provided. The electronic device is in communication with the separate display and user interface unit by means of a wired or wireless connection. In an embodiment, the electronic device is a mobile electronic device, such as a cellular phone, a PDA, a PND, a portable computer, an audio player or a mobile multimedia device. If such a device is provided with a portable projector as a display and user interface unit, user input is facilitated and display capabilities are improved. Further, the electronic device may itself not require a display and input unit, so that its size can be reduced.

According to another aspect of the invention, a method of operating a portable projector is provided, the method comprising the steps of projecting an image onto a projection surface and of stabilizing said projecting of said image. A region surrounding the portable projector is scanned for capturing picture data and a user input is detected by processing the captured picture data.

According to an embodiment, the stabilizing of the projecting of said image is based on the captured picture data. According to a further embodiment, the method may comprise the step of detecting a user controlled object in said picture data and of interpreting a variation of said user controlled object as a user input. Just as an example, image processing procedures may be used for detecting such a variation of a user controlled object.

According to another embodiment, the projected image represents a display signal, the display signal being received from an electronic device. Further, the user input and/or the captured picture data is supplied to the electronic device. Accordingly, the portable projector may operate as a display unit and/or an interface unit for the electronic device.

In a further embodiment, the stabilization of the projecting comprises the steps of processing the captured picture data for detecting a movement of the projection surface relative to the portable projector and adjusting the projecting so as to compensate for the detected movement. The picture data may thus be used for both detecting a user input and stabilization of the image projection.

In another embodiment, the captured picture data is analyzed for a deformation of the projection surface and a detected deformation is interpreted as a user input. As an example, the projection surface may comprise at least part of a hand, and a user input may then be detected by detecting a change of the texture of the hand, e.g. when applying pressure with a finger to the palm. User input may thus be facilitated. According to a further embodiment, the captured picture data is processed for detecting a predetermined user input, in response to which a projection surface is selected. The image is then projected onto the selected projection surface. Just as an example, a particular gesture may be detected, such as pointing a finger to a desired projection surface, onto which the image is then projected.

The captured picture data is in another embodiment analyzed for at least one marker present in the region observed by said scanning. The projecting of the image is then adjusted in response to position information of the at least one marker. This may for example be used for supporting the stabilization of the projecting or for supporting the detection of an appropriate projection surface. In a further embodiment, a shape of the projection surface is detected by processing the captured picture data. The format of the projected image is then adapted to the shape. If the projection surface is for example a palm, rotating the hand may result in a change from landscape to portrait format. According to a further embodiment, captured picture data is processed prior to projecting the image for detecting a user controlled object. In response to detecting said object, the projecting of the image is enabled. A predetermined variation of the user controlled object may also be detected for enabling the projecting of the image. Just as an example, a user may show or wave the hand in front of the projector, in response to which the projector starts to project the image.

Those skilled in the art will appreciate that one or more of the above-mentioned features may be combined. New embodiments may be formed by combining features of the above-mentioned embodiments and aspects of the invention.

The foregoing and other features and advantages of the invention will become further apparent from the following detailed description read in conjunction with the accompanying drawings.

### BRIEF DESCRIPTION OF THE DRAWINGS

Embodiments of the present invention are illustrated by the accompanying figures, wherein:

FIG. 1 illustrates an embodiment of a portable projector according to the invention;

FIG. 2 is a schematic drawing for illustrating another embodiment of a portable projector according to the invention;

FIG. 3 is flow diagram illustrating an embodiment of a method according to the invention;

FIG. 4 is a schematic drawing of another embodiment of a portable projector according to the invention, and further illustrates a possible use of a portable projector;

FIG. 5 is a flow diagram of another embodiment of the method according to the invention;

FIG. 6 is a schematic drawing of a further embodiment of a portable projector according to the invention. FIG. 6 further schematically shows an electronic device according to an embodiment of the invention.

Like reference symbols in the drawings indicated like elements.

### DETAILED DESCRIPTION OF THE INVENTION

A portable projector having the capability to recognize a user input by optical means may be used as a display and input unit for a mobile electronic device. The mobile electronic device establishes for example a wireless connection with the portable projector, e.g. using the Bluetooth™/® standard. The connection is then used to transmit a video signal from the mobile electronic device to the portable projector, and to transmit input data from the portable projector to the mobile electronic device. In consequence, there is no need for the user of the electronic device to actually access the electronic device, e.g. remove it from a pocket or bag, as the user is enabled to operate the device simply by means of the portable projector.

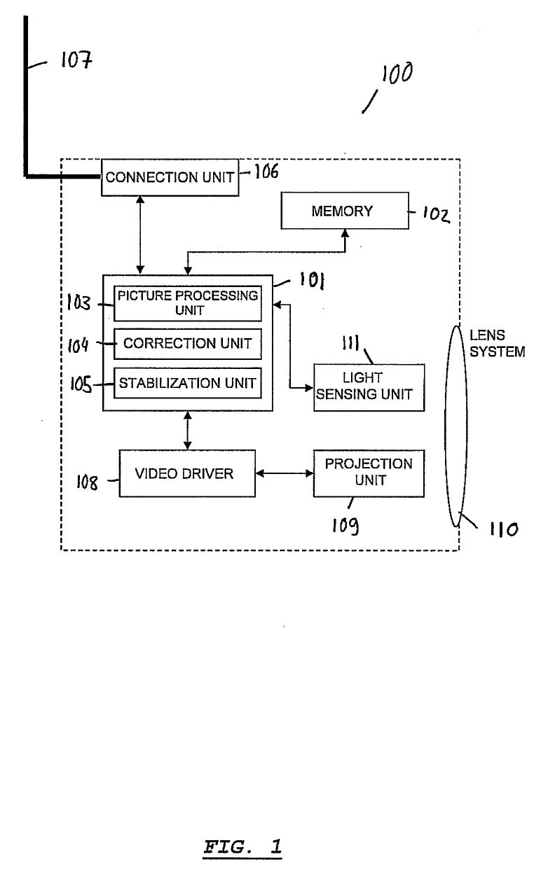

FIG. 1 illustrates an embodiment of a portable projector in accordance with the present invention. The block diagram of FIG. 1 shows portable projector 100 comprising a microprocessor 101. Microprocessor 101 controls the operation of portable projector 100 according to programs stored in memory 102. Memory 102 may incorporate all known kinds of memory, such as random access memory (RAM), read only memory (ROM), flash memory, EPROM or EEPROM memory, or a hard drive. Non-volatile memory may be used to store computer program instructions according to which portable projector 100 works. Microprocessor 101 may be implemented as a single microprocessor, or as multiple microprocessors, in the form of a general purpose or special purpose microprocessor, or a digital signal processor. In the embodiment of FIG. 1, a picture processing unit 103, a correction unit 104, and a stabilization unit 105 are implemented as software instructions being executed on microprocessor 101. The functioning of these units will be explained in detail later.

Microprocessor 101 interfaces connection unit 106, e.g. by means of a bus system and an input/output unit (not shown). Via connection unit 106, a connection to an electronic device, such as a mobile electronic device, is established through a connection cable 107. The electronic device transmits a display signal via the connection unit 106, the display signal being processed by microprocessor 101. The display signal is supplied by microprocessor 101 to video driver 108, e.g. via a data bus. Video driver 108 controls projection unit 109. Projection unit 109 may for example comprise a light source and a display element, such as an LCD element, and is capable of projecting an image by using lens system 110. Lens system 110 may comprise one or more lenses, depending on the desired optical properties of the lens system, which may be optimized for minimizing aberrations. Lens system 110 may further comprise movable lenses, which may be used to adjust the focus and the focal length of the lens system, yet they may also provide compensation for a movement of portable projector 100. Further, lenses may be moved in order to adjust the direction into which the image is projected.

A person skilled in the art will appreciate that the projecting of an image may be implemented in a variety of ways. Video driver 108 may for example be implemented with microprocessor 101. As projecting an image in accordance with a received video signal is known in the art, the processing of the video signal and the projecting will not be described in greater detail here.

Portable projector 100 further comprises light sensing unit 111. Light sensing unit 111 may comprise a CCD sensor, a CMOS sensor, a PND sensor or the like. It scans the region surrounding projector 100 by capturing a picture of the surrounding of the portable projector 100 through lens system 110. Light sensing unit 111 may thus be implemented as a camera unit. Light sensing unit 111 may also use a separate lens system. Picture data captured by light sensing unit 111 is supplied to microprocessor 101. A picture processing unit 103 analyzes the picture data for a user controlled object. For this purpose, image processing is employed. Picture processing unit 103 may for example use an edge detection algorithm for detecting features in the picture data, and it may use a recognition algorithm for recognizing objects in the captured image data. Picture processing unit 103 may for example be configured to recognize a range of predetermined objects, such as a hand, a palm, a finger, a pen, a ring or a reflector. If for example a hand is placed in front of lens system 110, the captured picture data comprises an image of the hand, which may then be recognized by picture processing unit 103. Picture processing unit 103 further detects a variation of a user controlled object and interprets it as a user input. When the palm of a hand is for example placed in front of lens system 110, picture processing unit 103 recognizes the palm as a command to start projecting an image. Accordingly, a control signal is generated by picture processing 103, in response to which microprocessor 101 initiates the projecting of a video signal received from connection unit 106 via video driver 108 and projecting unit 109. Picture processing unit 103 may furthermore recognize the movement of a particular object, and interpret it as a command. Examples are the pointing to a particular position with a finger, the pushing of a particular position on the projection surface, e.g. the palm, with the finger or a pen, or a rotation of the projection surface. Picture processing unit 103 may also be configured to analyze the texture of the projection surface, e.g. the texture of the hand, and interpreting a deformation as a user command. When a finger is pushed onto the palm of the hand, the texture changes, which can be detected by using edge or contour detection. Thus, the deformation can easily be recognized, and its detection is generally not affected by lighting conditions. Further, processing unit 103 may be configured to analyze shadows cast by a user controlled object, e.g. a finger. When the finger touches the projection surface, the shadow of the finger matches the finger. This can be detected as a user command. When the projection surface is deformed by pushing with a finger, a shadow is created when the light source is not perpendicular to the deformation. The shadow can be detected and interpreted as a user command.

Correction unit 104 further analyzes properties of the projection surface imaged in the picture data supplied by light sensing unit 111. For example, when using the palm of a hand as a projection surface, the projection surface has a particular texture, color and curvature. Correction unit 104 determines these properties, e.g. using image analysis, and performs a correction of the video signal supplied by connection unit 106, so that the quality of the image projected by projection unit 109 is improved. Correction unit 104 may make use of any known image correction method in order to optimize the projected image. Correction unit 104 may for example perform a color correction of the image, so that even on a colored projection surface the colors of the image are displayed as desired. For correction purposes, correction unit 104 may also work in a feedback configuration, wherein the properties of the projected image are tuned until the projected image exhibits the desired properties. The feedback signal in the form of captured picture data is delivered by light sensing unit 111 in this configuration.

Stabilization unit 105 stabilizes the projecting of the image onto the projection surface. Stabilization unit 105 may for example monitor the position of the projection surface in the captured picture data received from light sensing unit 111. Projection unit 109 may for example project an image larger than the image received with the video signal, with a frame around the video signal image being blacked out. The video image may then be shifted within the larger frame, so that its position stays constant on the projection surface, i.e. the position of the image is shifted together with the position of the projection surface, which is recognized from the captured picture data. The total projected image size may for example be 1600 times 1200 pixels, within which a smaller image, e.g. 800 times 600 pixels, corresponding to the video signal is moved. Using such a stabilization technique, the relative movement between the portable projector 100 and the projection surface is detected in the captured picture data, and the position of the projected image is adjusted in accordance with the detected relative movement. Those skilled in the art will appreciate that several other techniques for realizing such an image stabilization may also be implemented in the portable projector of the present embodiment, e.g. a stabilization by optical means.

Accordingly, by processing the picture data captured with light sensing unit 111 using microprocessor 101, image correction and image stabilization can be performed, and user inputs can be detected. User commands detected by picture processing unit 103 are then supplied to the electronic device via connection unit 106 and connection cable 107. In another embodiment, the captured picture data may be directly supplied to the electronic device, so that the electronic device can analyze the picture data for user commands.

The portable projector of the present embodiment thus provides a display and user interface unit for an electronic device. It can be constructed in a small size and lightweight, so that it is easy to use. As an electronic device using such a portable projector does not require additional input or display means, the size of the electronic device can be reduced. It should be clear that the portable projector 100 may comprise further components, such as a battery, an input/output unit, a bus system, etc., which are not shown in FIG. 1 for clarity purposes.

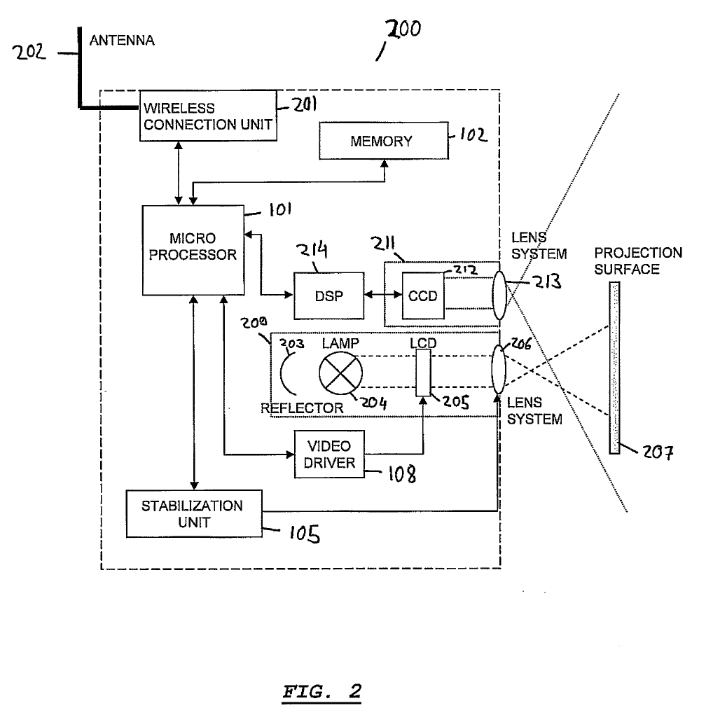

FIG. 2 shows a block diagram of another embodiment of a portable projector according to the invention. Portable projector 200 again comprises a microprocessor 101 and a memory 102. Microprocessor 101 interfaces a wireless connection unit 201, which establishes a wireless connection to an electronic device via antenna 202. A display signal is received via antenna 202. Microprocessor 101 interfaces projection unit 209 via video driver 108. Projection unit 209 comprises reflector 203, lamp 204, LCD element 205 and lens system 206. Those skilled in the art will appreciate that projection unit 209 may comprise further elements, such as polarizers, mirrors, an illumination lens system and the like. Lamp 204 may be implemented as one or more light emitting diodes (LED's) or organic LED's (oLED's), and illuminates LCD element 205. Video driver 108 delivers a control signal to LCD element 205, which forms an image in accordance with the signal, said image being projected by lens system 206 onto projection surface 207. Lens system 206 may again comprise several optical lenses, which may be fixed or movable. Projection surface 207 may for example be a wall, a sheet of paper, or the palm of a hand. Light sensing unit 211 comprises CCD sensor 212 and lens system 213. Lens system 213 is a wide angle lens system, so that picture data of the surroundings of the portable projector 200 can be captured over a large angular region. The sensor data supplied by CCD 212 are then processed by digital signal processor 214, and supplied to microprocessor 101. Instead of the CCD 212, a CMOS sensor or a PMD sensor may also be used. Using a wide angle lens system, the light sensing unit 212 is enabled to locate a projection surface 207, even if a large relative movement between the projection surface 207 and the portable projector 200 occurs. Raw image data provided by CCD 212 is processed by DSP 214, and the resulting captured picture data is supplied to microprocessor 101. Microprocessor 101 may process the supplied picture data as described with respect to FIG. 1, e.g. perform an image analysis for detecting a user input, perform an image correction in accordance with projection surface properties derived from analyzing the picture data, and perform a determination of the position of the projection surface 207 for stabilization purposes.

In the embodiment of FIG. 2, stabilization unit 105 is implemented as a separate unit actively driving a lens of a lens system 206 for image stabilization. By moving a lens of the lens system 206, e.g. in a plane perpendicular to the optical axis of the lens system, the direction in which the image is projected, can be adjusted. The adjusting is performed by stabilization unit 105 in such a way that the image is stabilized on the projection surface 207. Stabilization unit 105 may for example receive information on the position of projection surface 207 from microprocessor 101, and may then in accordance with that information send control signals to lens system 206. In another embodiment, stabilization unit 105 may comprise sensors for detecting a movement of portable projector 200, such as inertial or motion sensors, data from which sensors is then used for stabilization purposes. In a further embodiment, an active mirror controlled by stabilization unit 105 may be used in order to adjust the position of the projected image. Those skilled in the art will appreciate that there are several possibilities of implementing the image stabilization, and that different methods may be combined, such as performing a stabilization using a software running on microprocessor 101, or performing active stabilization using an electrically actuated mirror or moving lens.

In the embodiment of FIG. 2, the light sensing unit 211 captures a picture of the surroundings of portable projector 200, the region being larger than the image projected onto projecting surface 207 by projection unit 209. Accordingly, the captured picture data can be used to detect the position of the projection surface, to detect the variation of a user controlled object as a user input, and to detect properties of the projection surface for image correction purposes. As the captured picture data comprises the projected image, the color and potential distortions of the projected image can be analyzed and corrected by image processing techniques. As an example, a color correction may be performed and a curvature of the projection surface may be corrected for.

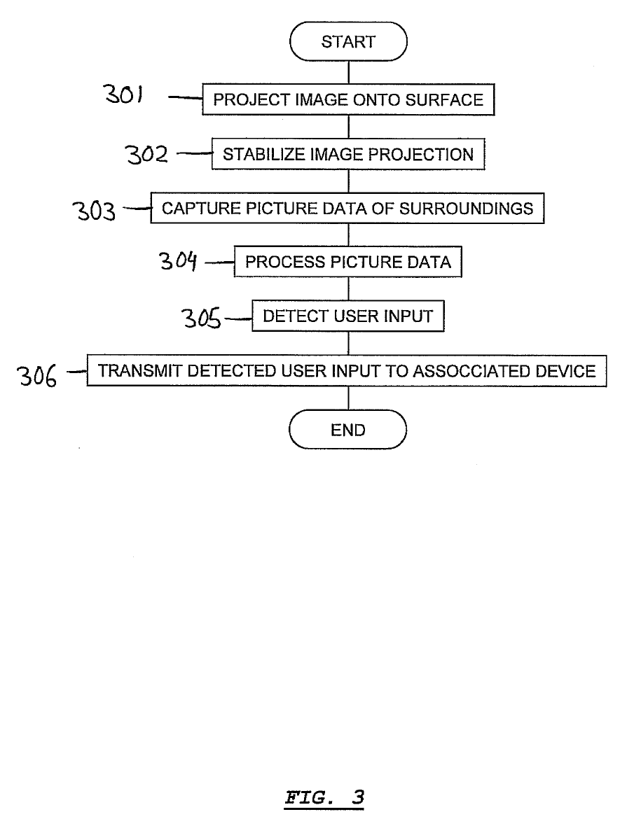

FIG. 3 shows a flow diagram of an embodiment of the method according to the invention. In a first step 301, an image is projected onto a projection surface. The image represents a video signal or display signal received by a portable projector from an electronic device. By projecting the image, the portable projector is operated as the fully functional display of the electronic device, and may as such display the same graphical elements as generally shown on a built-in display. The projected image may as such comprise a function menu structure, graphical control elements, graphical representations of information, graphical images or animated video.

In step 302, image projection is stabilized. Stabilization may occur according to data provided by sensors internal to the portable projector, according to data provided by image capturing sensors, or according to captured picture data captured by a light sensing unit, such as light sensing unit 111 or 211. In step 303, picture data of the surroundings of the portable projector is captured. The picture data is processed in step 304. Processing may comprise image analysis methods, such as edge detection, filtering, transformation (e.g. Fourrier transformation, etc.), thresholding, and the like. When processing the picture data, user controlled objects are identified. These may be recognized by using an image recognition technique, based for example on feature extraction, statistical methods, syntactic or structural methods, neuronal networks or pattern matching. A person skilled in the art will appreciate that a range of methods may be implemented for processing the captured picture data, such as methods commonly used in computer vision and image analysis. A user controlled object is for example classified and its movement tracked, so as to detect a predetermined variation of the object.

By determining that a predetermined variation of the user controlled object has occurred, a user input is detected in step 305. A user may for example use the palm of his hand as a projection surface. When slightly rotating the hand up or down, this may be detected by processing the captured picture data and interpreted as a command for scrolling up or down through a list or the like. From a list of elements, a user may then select an element by flicking a finger, which is again recognized by processing the picture data. The user may for example flick the index finger to select an element, while flicking the ring finger corresponds to a command for going back to a higher menu level. The user may also wave the hand back and forth for moving through files or pictures. For a more advanced input, the user may use the other hand just like a pen on a touch screen. He may press his finger onto the palm onto which the image is projected for selecting a control element in the image. The deformation in the palm can then be detected, and can be interpreted as a command, i.e. as activation of the graphical control element. The user may also use the fingers of the same hand for inputting commands.

The detected user input is then transmitted to the associated electric device in step 306. As explained with reference to FIGS. 1 and 2, the user input may be transmitted by means of a wired or wireless connection.

It should be clear that the above-described methods may be continuously performed, i.e. the image is projected onto the projection surface, while picture data is captured and processed in order to detect a user input. Stabilization can constantly be carried out while the image is projected onto the projection surface. With such a method, the user is both provided with information from the electronic device and is enabled to control the electronic device without the need to actually physically access the electronic device.

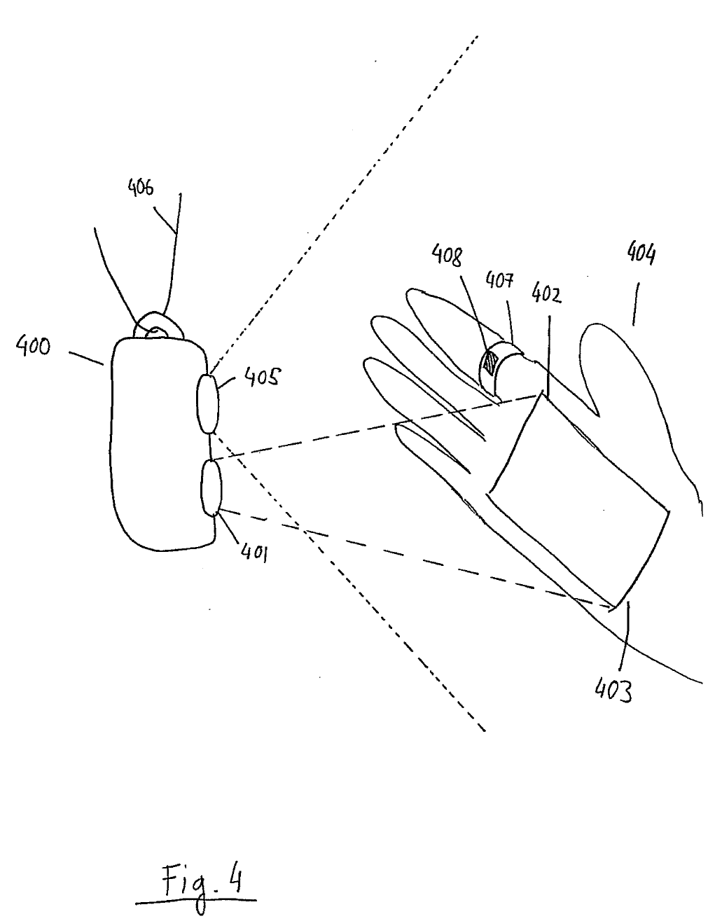

FIG. 4 schematically shows a portable projector 400 comprising a lens system 401 for projecting an image 402. In the example of FIG. 4, the image 402 is projected onto the palm 403 of a hand 404. Portable projector 400 further comprises a lens system 405, using which picture data of the surroundings of projector 400 is captured. Portable projector 400 is implemented as a piece of jewelry worn on necklace 406 around the neck of the user. Portable projector 400 may operate as explained with reference to FIG. 2, and may receive a display signal via a wireless connection to an associated electronic device. The index finger of the hand 404 is carrying a ring 407 provided with a marker 408. The marker 408 is configured such that it is easily recognized by the processing of the captured picture data performed in portable projector 400. The marker may also be an active marker, which can be detected even in complete darkness. Further, UV/IR light may be used to help detecting the projection surface. As the marker is easily recognized, the position of the projection surface, here palm 403, can easily be derived and a change of the relative position between hand and portable projector can easily be detected. Accordingly, a stabilization of the projected image on the projection surface can be further improved. Yet as an open hand and a palm are relatively straight forward to detect in the captured picture data, providing ring 407 and marker 408 are optional.

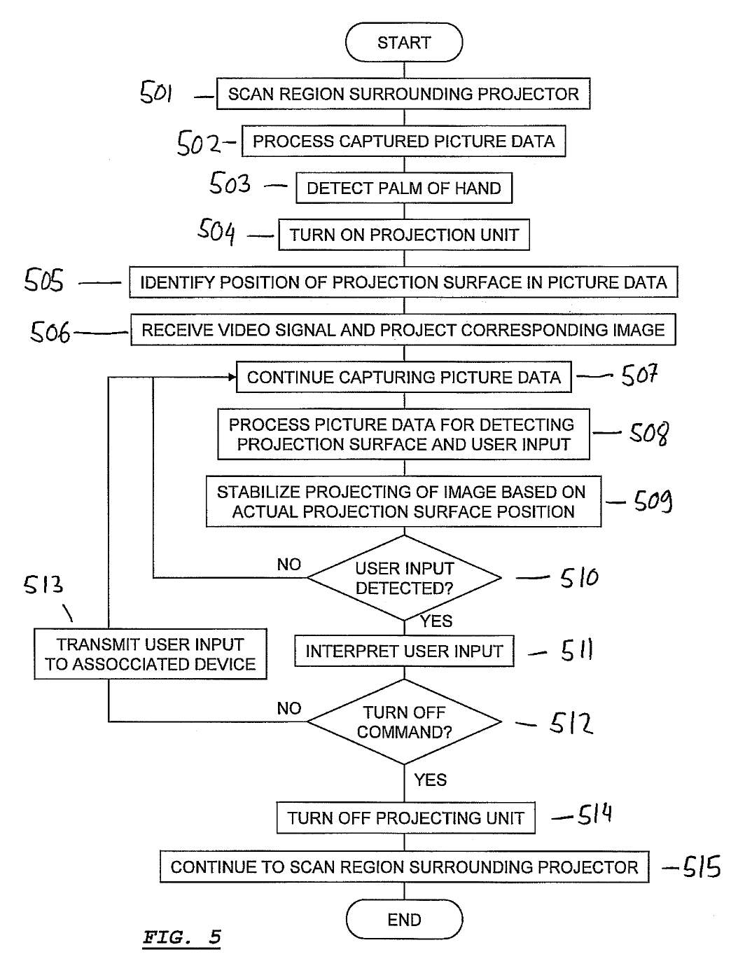

Turning now to FIG. 5, a flow diagram of another embodiment of a method according to the invention is shown. In a first step 501, a region surrounding the portable projector is scanned. When implemented as shown in FIG. 2, the region may be scanned by the light sensing unit 211 capturing picture data of the surrounding of the projector. The region may be scanned even when the portable projector is not active, i.e. when not projecting an image. A user input may thus be detected even when the projector is not active. The captured picture data is processed in step 502. The captured picture data is for example analyzed for the shape of an open hand. If a user places an open hand in front of the portable projector, the palm of the hand is detected in step 503. Detecting an open hand is interpreted as command for activating the projector. The projection unit is turned on in step 504, meaning that the portable projector initiates the projecting of an image. In step 505, the position of the projection surface is identified in the picture data. As in the present example, the projection surface is the palm of the hand, the position of the palm is identified. A video signal from an associated electronic device is received in step 506, and a corresponding image is projected onto the identified projection surface. The portable projector may for example transmit a signal to the electronic device so as to trigger the electronic device to start sending the video signal.

The capturing of picture data continues as indicated in step 507. In step 508, the picture data is processed for detecting the projection surface and a further user input. Based on the detected actual projection surface position, the projecting of the image is stabilized in step 509. Several possibilities of how the stabilization can be implemented are discussed above with reference to FIGS. 1 and 2. When a user input is not detected by processing the captured picture data, the capturing of picture data continues in step 507. It should be clear that the projecting of the image also continues. If a user input is detected in step 510, the user input is interpreted in step 511. A range of predetermined variations of user controlled objects may be stored as a kind of command library in a memory of the portable projector. A turn off command may for example be defined, in response to which the portable projector deactivates the projecting of an image. If the command is determined to not be a turn of command in decision 512, then the detected user input is transmitted to the associated electronic device in step 513. The capturing of picture data is then continued again in step 507. User input may comprise a range of different commands. These commands may be either commands for the projector itself, such as turn-on and turn-off commands, or commands associated with the electronic device. As an example, the user may point towards a wall, which is interpreted by the portable projector as a command to start projecting onto the wall. The projected image may thus be transferred from the palm of the hand to the wall. As different projection surfaces may be used, different modes of stabilization may be used as well. The image may for example be either hold still on the projection surface, which is advantageous for a wall, or it may be moved together with the projection surface, e.g. when projecting onto a hand. Accordingly, even if the user moves his hand, the image will still be clearly visible.

A turn-off command may for example be implemented as a waving of the hand in front of the projector. If such a turn-off command is detected in decision 512, the projection unit is turned off in step 514, i.e. the projector goes into a passive state. In said state, the projector continues to scan the region surrounding it in step 515. The method then starts over, e.g. with step 501. The projector may be provided with an additional button for completely deactivating the projector.

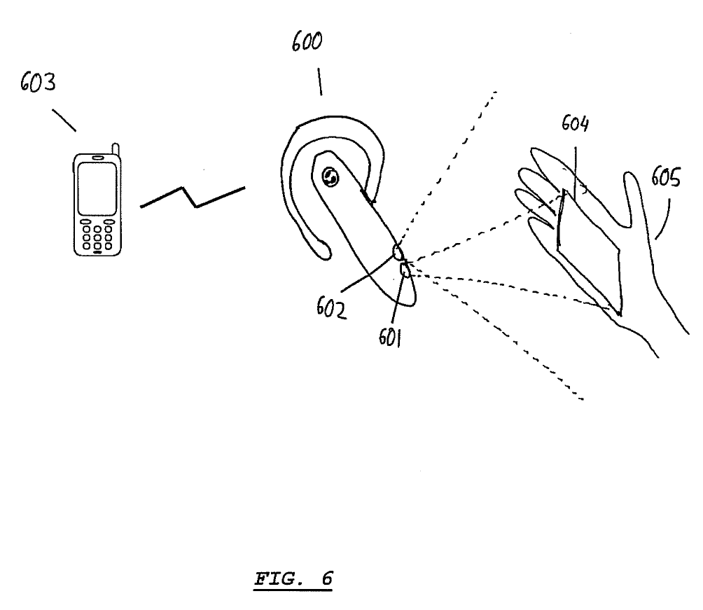

FIG. 6 shows another embodiment of a portable projector according to the invention. The portable projector 600 has the form of a headset with integrated means for communication, e.g. a loudspeaker and a microphone. The portable projector 600 again comprises a lens system 601 for projecting an image, and a lens system 602 for capturing picture data. The portable projector 600 communicates with electronic device 603. In the present embodiment, electronic device 603 is implemented as a cellular phone, yet it may be implemented as any other electronic device, such as a PDA, an audio player, a portable computer, and the like. Preferably, electronic device 603 is a mobile electronic device. Portable projector 600 operates both as display unit and user interface for cellular phone 603. Accordingly, cellular phone 603 does not need to be provided with a display and control elements/a keyboard, yet these may be still be provided. Cellular phone 603 sends a display signal to portable projector 600 and receives user commands detected by portable projector 600. Again, portable projector 600 may operate in a passive state until detecting a turn-on command, such as an open hand, in response to which the sending of the display signal by the mobile electronic device 603 is initiated. The corresponding image 604 is then projected onto the palm of the hand 605. It should be clear that any other surface may be used as a projection surface, in particular as the portable projector 600 may be provided with means for correcting the projecting of the image so as to achieve a good image quality. As such, the projection surface may be a wall, a sheet of paper, and the like.

Those skilled in the art will appreciate that the portable projector of the present invention may also be implemented as another object, such as a pin, a button, another object attached to the clothing of the user, and the like.

As the portable projector can be implemented to operate as a fully functional user interface and display unit, the associated electronic device can be kept to a small size and there is no need to get the electronic device out of the pocket when desiring to operate it. Further, the display area provided by the portable projector can be a multiple of the display size of the associated electronic device. Further, a simple and multifunctional control for the electronic device is provided, and intuitive commands can be implemented, similar to those of a touch screen. Also, additional gesture commands can be detected and interpreted by the portable projector.

While specific embodiments of the invention are disclosed herein, various changes and modifications can be made without departing from the spirit and the scope of the invention. The present embodiments are to be considered in all respect as illustrative and non-restrictive, and all changes coming within the meaning and equivalency range of the appended claims are intended to be embraced therein.

1-35. (canceled)

36. A portable projector comprising:
a projection unit to project an image onto a projection surface;
a stabilization unit to stabilize the projected image; and
a light sensing unit to perform a scan of a region near the portable projector, wherein the portable projector is configured to operate as a user interface by detecting a user input based on the scan.

37. The portable projector of claim 36, wherein the light sensing unit is configured to capture picture data, the stabilization unit to stabilize the projected the image based on the captured picture data.

38. The portable projector of claim 36, further comprising:
a processing unit to analyze picture data captured by the light sensing unit for a user controlled object, wherein the processing unit is configured to detect a user input by detecting a variation of the user controlled object.

39. The portable projector of claim 38, wherein the user controlled object comprises at least one of a hand, a palm, a finger, a pen, a ring, or a reflector.

40. The portable projector of claim 36, wherein the stabilization unit is configured to correct for movements of the projection surface.

41. The portable projector of claim 36, wherein the projection surface comprises at least a part of a hand of the user.

42. The portable projector of claim 36, wherein the stabilization unit is configured to correct for movements of the portable projector.

43. The portable projector of claim 36, further comprising:
a connection unit to establish a connection to an electronic device, the portable projector being configured to operate as a display unit and as a user interface for the electronic device.

44. The portable projector of claim 43, wherein the connection is a wireless connection.

45. The portable projector of claim 36, further comprising:
a processing unit to process picture data captured by the light sensing unit to detect a position and a shape of the projection surface, the processing unit being further configured to adjust the projected image based on the detected position and the detected shape.

46. The portable projector of claim 36, further comprising:
a processing unit to process picture data captured by the light sensing unit to detect at least one marker present in the region scanned by the light sensing unit, the stabilization unit being configured to adjust the projected image based on a position of the at least one marker in the region.

47. The portable projector of claim 36, further comprising:
an image correction unit configured to correct the projected image based on picture data captured by the light sensing unit for at least one property of the projection surface, the at least one property including at least one of a color, a texture, a curvature, or a shape.

48. The portable projector of claim 36, further comprising:
a processing unit to analyze picture data captured by the light sensing unit to determine a deformation of the projection surface and to interpreting the determined deformation as the user input.

49. The portable projector of claim 36, further comprising:
a processing unit to analyze picture data captured by the light sensing unit for a shadow of a user controlled object, for interpreting a shadow with a predetermined shape in relation to the user controlled object, or an appearance or disappearance of a shadow, as a user input.

50. The portable projector of claim 36, wherein the portable projector is implemented in an earpiece, a headset, a pin, a jewelry article, or a button.

51. In a portable projector, a method comprising:
projecting an image onto a projection surface;
stabilizing the projecting the image;
performing a scan of a region near the portable projector to capture picture data; and
processing the captured picture data to detect a user input.

52. The method of claim 51, wherein the stabilizing the projecting of the image is based on the captured picture data.

53. The method of claim 51, wherein the processing the captured picture data comprises:
detecting a user controlled object in the captured picture data, and
interpreting a variation of the user controlled object as the user input.

54. The method of claim 51, further comprising:
receiving a display signal from an electronic device, wherein the projected image represents the display signal; and
supplying at least one of the user input or the captured picture data to the electronic device.

55. The method of claim 51, wherein the stabilizing the projecting comprises:
processing the captured picture data to detect a movement of the projection surface relative to the portable projector, and
adjusting the projecting based on the detected movement.

56. The method of claim 51, wherein the projection surface comprises at least a portion of a hand of the user, the method further comprising:
analyzing the captured picture data to determine a deformation of the projection surface, and
interpreting the determined deformation as the user input.

57. The method of claim 51, further comprising:
selecting the projection surface based on the user input detected by processing the captured picture data.

58. The method of claim 51, further comprising:
analyzing the captured picture data to detect at least one marker present in the scanned region; and
adjusting the projecting of the image based on position information associated with the detected at least one marker.

59. The method of claim 51, further comprising:
processing the captured picture data to determine a shape of the projection surface; and
adapting a format of the projected image to the determined shape.

60. The method of claim 51, further comprising:
processing the captured picture data before the projecting the image to detect a user controlled object; and
responsive to the detection of the object, enabling the projecting the image.

61. A portable projector comprising:
a projection unit to project an image onto a projection surface;
a light sensing unit to scan a region in an area of the portable projector; and
a connection unit to establish a connection to an electronic device, wherein the portable projector is configured to operate as a display unit and a user interface for the electronic device by detecting a user input using the light sensing unit.

62. The portable projector of claim 61, wherein the projection surface comprises at least a portion of a body part.

63. The portable projector of claim 61, further comprising:
a stabilization unit to stabilize the projected image based on picture data captured by the light sensing unit.

64. The portable projector of claim 61, further comprising:
a processing unit to analyze picture data captured by the light sensing unit, wherein the user input is detected by detecting a user controlled object in the captured picture data.

65. The portable projector of claim 61, wherein the light sensing unit comprises a sensor including at least one of a charged coupled device (CCD) sensor, a complementary metal-oxide-semiconductor (CMOS) sensor, or a photonic mixer device (PMD) sensor.

66. A portable projector comprising:
a projection unit to project an image onto a projection surface;
a light sensing unit to scan a region near the portable projector, the light sensing unit to capture image data of the region; and
a stabilization unit to stabilize the projected image based on the captured image data;
wherein the stabilization unit is configured to account for a relative movement between the projection surface and the portable projector.

67. The portable projector of claim 66, further comprising:
a processing unit to analyze the captured image data to detect a user controlled object therein and interpret a characteristic of the user controlled object as the user input, wherein the portable projector is enabled to operate as a user interface based on the interpreted characteristic.

68. A method of operating a portable projector, the comprising:
receiving a display signal from an electronic device;
projecting an image corresponding to the display signal onto a projection surface;
capturing a plurality of images within range of the portable projector;
detecting a user input using the captured images; and
supplying the user input to the electronic device, wherein the portable projector functions as a display unit and as a user interface associated with the electronic device.

69. The method of claim 68, wherein the receiving the display signal comprises receiving the display signal via a wireless connection.

70. The method of claim 68, wherein the electronic device comprises a cellular phone, a personal digital assistant (PDA), a personal navigation device (PND), a portable computer, an audio player, or a mobile multimedia device.
